(19) United States
(12) Patent Application Publication
(10) Pub. No.: US 2023/0344219 A1
(43) Pub. Date: Oct. 26, 2023

(54) CURRENT SENSOR POWERED FAULT CURRENT LIMITER

(71) Applicant: G & W ELECTRIC COMPANY, Bolingbrook, IL (US)

(72) Inventor: Juan Serrano Puche, Chicago, IL (US)

(21) Appl. No.: 17/729,875

(22) Filed: Apr. 26, 2022

(51) Int. Cl. H02H 9/02; H02H 1/00

(52) U.S. Cl. CPC H02H 9/02; H02H 1/0007

(57) ABSTRACT

Systems and methods for providing a current limiting system comprising a current limiter for a high-voltage power distribution system, and interrupter, and a current sensing system. The current limiter includes a primary path and a secondary path and is configured to direct an input current to flow through the primary path while the primary path is closed and direct the input current to flow through the secondary path while the primary path is open. The interrupter is configured to receive a triggering signal and, in response to receiving the triggering signal, open the primary path. The current sensing system includes a voltage divider and a voltage suppression device and is configured to receive the input current; divide, with the voltage divider, a voltage associated with the input current into a divided voltage; and in response to the input current exceeding a predetermined current threshold, output the divided voltage as the triggering signal.

### FIELD OF DISCLOSURE

Aspects described herein relate to limiting current in high voltage electrical systems. More particularly, aspects described herein relate to systems and methods for limiting or interrupting a fault current in a high voltage electrical system when a current through a current sensor exceeds a defined trigger.

### SUMMARY

In high voltage power distribution systems, power transmission equipment may experience fault current situations. In a fault current situation, a current flowing through the power transmission equipment may exceed an operation range of the equipment. In these cases, the power transmission equipment may become damaged. Current limiters are devices which limit an amount of current that can travel through power transmission equipment to a safe operating level. For example, a current limiter may be connected to power transmission equipment to reduce the current flowing through the power transmission equipment in a fault current situation. However, some current limiters may require additional power to operate, increasing the complexity of the power transmission system.

Therefore, it may be beneficial to implement self-powering current limiting electronics within a current limiter. For example, self-powered current limiting electronics may be constructed such that a current flowing through the current limiter provides power to triggering electronics to trigger the current limiter. Embodiments described herein provide systems and methods for implementing self-powered current limiting electronics.

In particular, embodiments described herein provide a current limiting system comprising a current limiter for a high-voltage power distribution system, and interrupter, and a current sensing system. The current limiter includes a primary path and a secondary path and is configured to direct an input current to flow through the primary path while the primary path is closed and direct the input current to flow through the secondary path while the primary path is open. The interrupter is configured to receive a triggering signal and, in response to receiving the triggering signal, open the primary path. The current sensing system includes a voltage divider and a voltage suppression device and is configured to receive the input current; divide, with the voltage divider, a voltage associated with the input current into a divided voltage; and in response to the input current exceeding a predetermined current threshold, output the divided voltage as the triggering signal.

Other embodiments described herein provide a method of limiting a current in a high-voltage power distribution system. The method includes directing, with a current limiter of the high-voltage power distribution system, the current limiter having a primary path and a secondary path, an input current to flow through the primary path while the primary path is closed. The method includes directing, with the current limiter, the input current to flow through the secondary path while the primary path is open. The method includes receiving, with at an interrupter of the high-voltage power distribution system, a triggering signal. The method also includes, in response to receiving the triggering signal, opening the primary path with a current sensing system including a voltage divider and a voltage suppression device by: receiving, with the current sensing system, the input current; dividing, with the voltage divider, a voltage associated with the input current into a divided voltage; and in response to the input current exceeding a predetermined current threshold, outputting the divided voltage as the triggering signal.

Other aspects of the disclosure will become apparent by consideration of the detailed description and accompanying drawings.

### BRIEF DESCRIPTION OF THE DRAWINGS

FIG. 1A is a perspective view of a low-voltage current limiting system.

FIG. 1B is a perspective view of a medium-voltage current limiting system

FIG. 2 is a block diagram illustrating the components of a current limiting system.

FIGS. 3A-C illustrate a circuit for use in a current limiting system, according to some aspects.

FIG. 4 is a block diagram illustrating a control system for a detonator of a current limiting system, according to some aspects.

FIG. 5 is a self-powered current sensing circuit using a generic voltage suppression device, according to some aspects.

FIG. 6 is a flowchart illustrating a method of controlling the self-powered current sensing circuit of FIG. 5, according to some aspects.

FIG. 7 is a self-powered current sensing circuit using a transient-voltage-suppression (TVS) device, according to some aspects.

FIG. 8 is a flowchart illustrating a method of controlling the self-powered current sensing circuit of FIG. 7, according to some aspects.

FIG. 9 is a graph illustrating the output of a current transformer and a firing pulse applied to a detonator of a current limiting system using the self-powered current sensing circuit of FIG. 7, according to some aspects.

FIG. 10 is a self-powered current sensing circuit using two Zener diodes and a TRIAC, according to some aspects.

FIG. 11 is a flowchart illustrating a method of controlling the self-powered current sensing circuit of FIG. 10, according to some aspects.

FIG. 12 is a graph illustrating the output of a current transformer and a firing pulse applied to a detonator of a current limiting system using the self-powered current sensing circuit of FIG. 10, according to some aspects.

### DETAILED DESCRIPTION

One or more embodiments and aspects are described and illustrated in the following description and accompanying drawings. These embodiments and aspects are not limited to the specific details provided herein and may be modified in various ways. Furthermore, other embodiments and aspects may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium.

Also, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

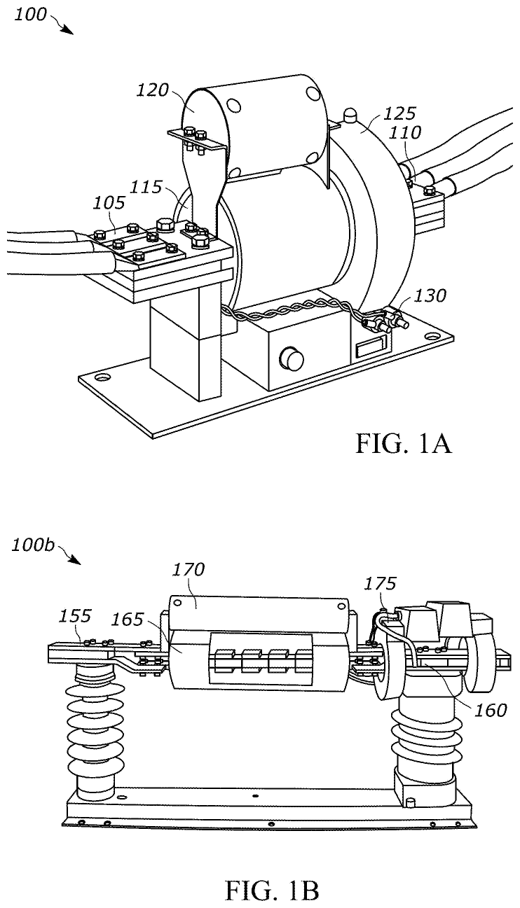

FIG. 1A is a perspective view of a low-voltage current limiting system 100a (also referred to as a CLiP). The low-voltage current limiting system 100a is configured to interrupt a current traveling through a low-voltage electrical system (for example, a device in a high voltage power distribution system) from exceeding a rated current for the device. The low-voltage current limiting system 100a includes a supply voltage line 105 and a load voltage line 110. In some instances, the current limited by the low-voltage current limiting system 100a flows between the supply voltage line 105 and the load voltage line 110. In other instances, the current limited by the low-voltage current limiting system 100a flows in the opposite direction. The low-voltage current limiting system 100a includes a first current bus 115 and a second current bus 120 (for example, a current-limiting fuse). In some instances, the first current bus 115 and the second current bus 120 are parallel current buses. In some instances, the first current bus 115 is a primary path for the current under normal operating conditions, and the second current bus 120 is a secondary path for the current under abnormal operating conditions. The low-voltage current limiting system 100a is configured to direct an input current to flow through the first current bus 115 while the first current bus 115 is closed, and to direct the input current to flow through the second current bus 120 while the first current bus 115 is open.

The low-voltage current limiting system 100a also includes a current transformer 125 that is configured to monitor a current level through the low-voltage current limiting system 100a. The current transformer 125 includes a sensing and firing logic system which sends a firing signal in response to determining that the current level through the low-voltage current limiting system 100a has exceeded a current threshold. The firing signal is sent over a wire coil 130 to the first current bus 115. Upon receiving the firing signal, an explosive portion of the first current bus 115 detonates, opening a portion of the first current bus 115 and causing the first current bus 115 to function as an open circuit. The current then travels through the second current bus 120. The second current bus 120 may be a current limiting fuse which melts, gradually reducing current flow through the low-voltage current limiting system 100a.

FIG. 1B is a perspective view of a medium-voltage current limiting system 100b (also referred to as a CLiP). The medium-voltage current limiting system 100b is configured to prevent a current traveling through a high-voltage electrical system (for example, a device in a high voltage power distribution system) from exceeding a rated current for the device. The medium-voltage current limiting system 100b includes a supply voltage line 155 and a load voltage line 160. In some instances, the current limited by the medium-voltage current limiting system 100b flows between the supply voltage line 155 and the load voltage line 160. In other instances, the current limited by the medium-voltage current limiting system 100b flows in the opposite direction. The medium-voltage current limiting system 100b includes a first current bus 165 and a second current bus 170. In some instances, the first current bus 165 and the second current bus 170 are parallel current buses. In some instances, the first current bus 165 is a primary path for the current under normal operating conditions, and the second current bus 170 is a secondary path for the current under abnormal operating conditions. The medium-voltage current limiting system 100b is configured to direct an input current to flow through the first current bus 165 while the first current bus 165 is closed, and to direct the input current to flow through the second current bus 170 while the first current bus 165 is open.

The medium-voltage current limiting system 100b also includes a current transformer 175 that is configured to monitor a current level through the medium-voltage current limiting system 100b. The current transformer 175 is connected to a sensing and firing logic system which sends a firing signal in response to determining that the current level through the medium-voltage current limiting system 100b has exceeded a current threshold. The firing signal is sent to a detonator on the first current bus 165. Upon receiving the firing signal, an explosive portion of the first current bus 165 detonates, opening a portion of the first current bus 165 and causing the first current bus 165 to function as an open circuit. The current then travels through the second current bus 170. The second current bus 170 includes a current limiting fuse which melts, gradually reducing current flow through the medium-voltage current limiting system 100b.

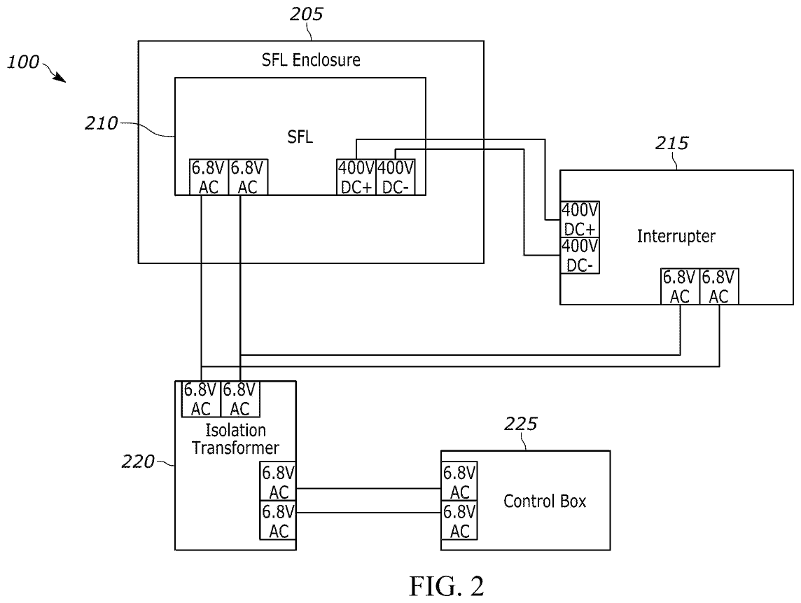

FIG. 2 is a block diagram illustrating the components of a current limiting system (such as the low-voltage current limiting system 100a or the medium-voltage current limiting system 100b, referred to generically as the current limiting system 100). In the example illustrated, the current limiting system 100 includes a sensing-and-firing logic (SFL) enclosure 205. The enclosure 205 houses an SFL controller 210. The SFL controller 210 is configured to receive a signal related to a current in the current limiting system 100 and send a firing signal to an interrupter 215. In some instances, the firing signal is sent in response to a current level of the current limiting system 100 exceeding a current threshold and is a direct-current signal and may be in the range of 0V to 400V. The SFL controller 210 is also connected to an isolation transformer 220. The isolation transformer 220 provides power to the SFL controller 210.

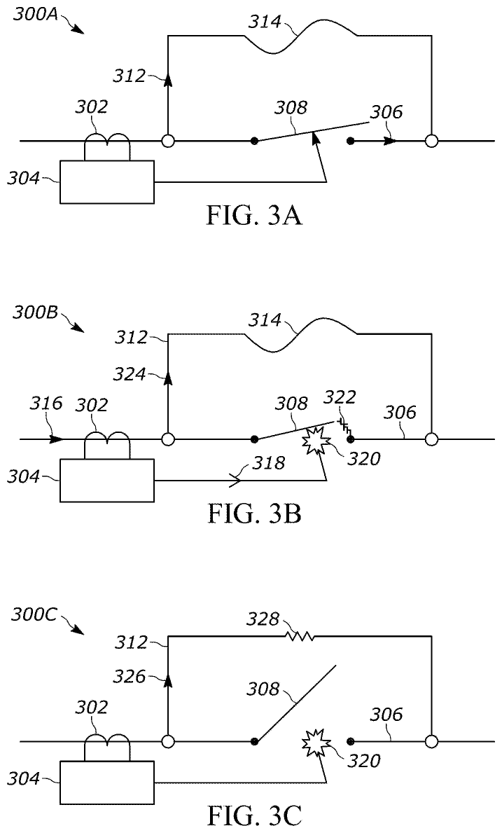

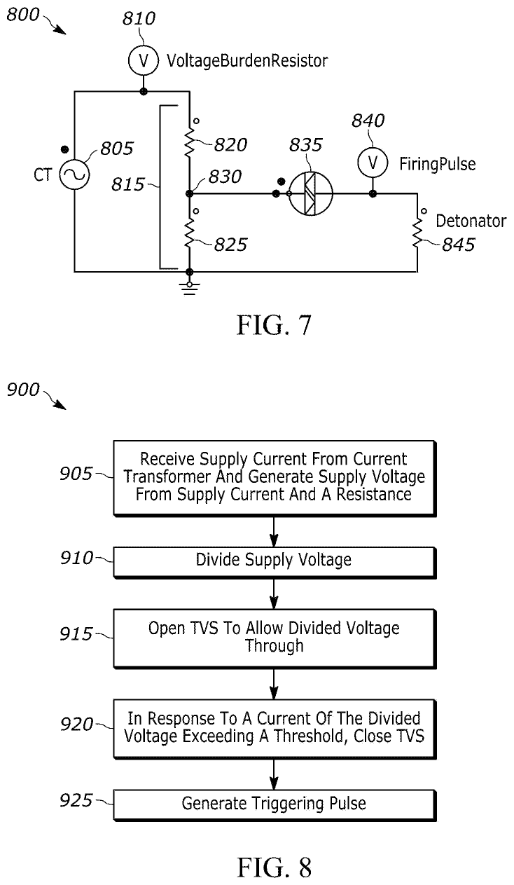

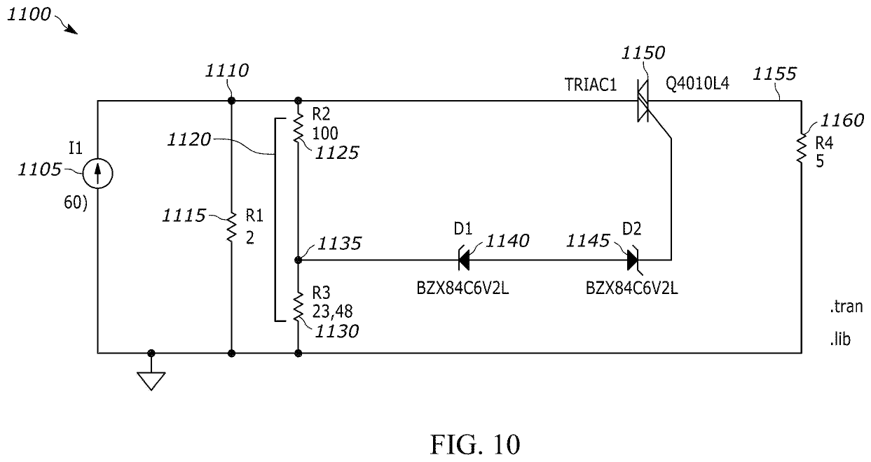

FIGS. 3A-C illustrate a circuit 300 for use in a current limiting system 100. FIG. 3A illustrates the circuit 300A at a first time. The circuit 300A includes a current sensor 302. In some instances, the current sensor is a current transformer. The current sensor 302 may be connected to a triggering logic block 304. The triggering logic block 304 is connected to a current transformer. In some instances, the triggering logic block 304 is implemented by one or more circuit components. For example, referring to FIG. 7, a transient-voltage suppression (TVS) device is used as the triggering logic block 304. Similarly, referring forward to FIG. 10, a TRIAC is used as the triggering logic block 304. In either instance, the use of a simplified component (i.e., the TVS or the TRIAC) simplifies the current limiting system 100.

The circuit 300A also includes a primary current path 306 configured to permit current flow through itself (low resistance) under normal operating conditions. A current flowing through the primary current path 306 is monitored by the current sensor 302. The primary current path 306 includes an explosive portion 308 configured to be opened based on the triggering logic block. The explosive portion 308 is controlled by the triggering logic block 304 so that when the current sensor 302 determines that the current flowing through the primary current path 306 exceeds a current limit, the explosive portion 308 receives a firing pulse from a detonator connected to the triggering logic block 304 to disconnect the primary current path 306. The circuit 300A also includes a secondary current path 312 configured to substantially prohibit current flow through itself under normal operating conditions, by having a higher resistance than the primary current path 306. The secondary current path 312 includes a current limiting fuse 314 configured to melt in response to an overcurrent.

FIG. 3B illustrates the circuit 300B at a second time that is later than the first time. The circuit 300B illustrates an overcurrent situation occurring within the primary current path 306, indicated by a fault current 316 on the primary current path 306. The fault current 316 is detected by the current sensor 302. The triggering logic block 304 generates a firing pulse 318 in response to the current sensor 302 detecting the fault current 316. The firing pulse 318 is received by the explosive portion 308. In response to receiving the firing pulse 318, the explosive portion 308 may create an explosion or a detonation 320 (graphically depicted as star) to open the primary current path 306 at the explosive portion 308. While the primary current path 306 is opening, an arc 322 is generated between the explosive portion 308 and the primary current path 306, allowing a limited current 324 to be commutated from the primary current path 306 to the secondary current path 312.

FIG. 3C illustrates the circuit 300C at a third time that is later than the second time. The circuit 300C illustrates that the detonation 320 has ended and the primary current path 306 has opened completely, so that no current flows through the primary current path 306. Instead, all current 326 flows through the secondary current path 312. The current 326 is limited by the current limiting fuse 328, which melts in response to the current 326 flowing through the current limiting fuse 328. Melting of the current limiting fuse 328 further limits the current 326, until the current limiting fuse 328 has melted completely and no current is able to flow through the circuit 300C.

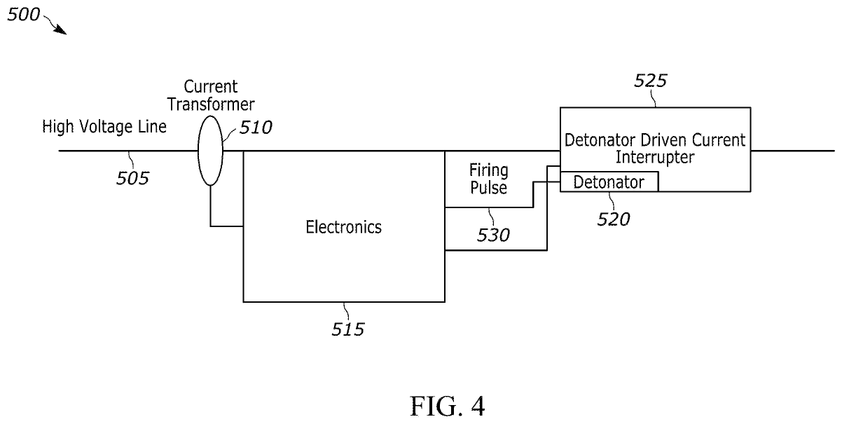

FIG. 4 is a block diagram illustrating a control system 500 for a detonator-based current limiting system 100. The control system 500 may be implemented by the current transformer 125 or 175 of the current limiting system 100. The control system 500 includes a high voltage line 505. In some instances, the high voltage line 505 is a power line supplying high voltage power to one or more high voltage devices. In some instances, the high voltage line 505 supplies power to a current transformer 510. The current transformer 510 provides a current signal to an electronic circuit 515. The electronic circuit 515 controls a detonator 520 of a detonator driven current interrupter 525 via a firing pulse line 530. In some instances, the electronic circuit 515 includes circuitry for monitoring the current signal and determining whether the current signal has exceeded a limit value. In some instances, the detonator driven current interrupter 525 interrupts a current flow of the high voltage line 505. The electronic circuit 515 may be implemented in a number of different instances. One example is illustrated in FIG. 5. A second instance is illustrated in FIG. 7. A third instance is illustrated in FIG. 10.

As noted above, the electronic circuit 515 of the control system 500 can be implemented in a number of ways including via a self-powered current sensing circuit 600 using a generic voltage suppression device, illustrated in FIG. 5. The circuit 600 includes a current transformer 605 configured to receive a current signal from a high voltage source. In some instances, the current signal is received from a high voltage line, such as the high voltage line 505. The current transformer 605 outputs a current signal at a first node 610 of the circuit 600. The supply voltage is supplied to a voltage divider 615 including a first resistor 620 and a second resistor 625, with a second node 630 between the first resistor 620 and the second resistor 625. The voltage is supplied from the second node 630 to a voltage suppression device 635 connected to a third node 640. In some instances, the voltage suppression device 635 determines whether a current associated with the supply voltage exceeds a current threshold. In a first example, the current does not exceed the current threshold. In this example, the voltage suppression device 635 functions as an open circuit so that no voltage or current is supplied to the third node 640. In a second example, the current exceeds the current threshold. In this example, the voltage suppression device 635 functions as a short circuit so that a voltage or current signal is supplied to the third node 640, across a load 645. In some embodiments, the load 645 is a detonator. The circuit 600, although discussed with respect to being implemented in a current limiting system 100, may be used in other applications.

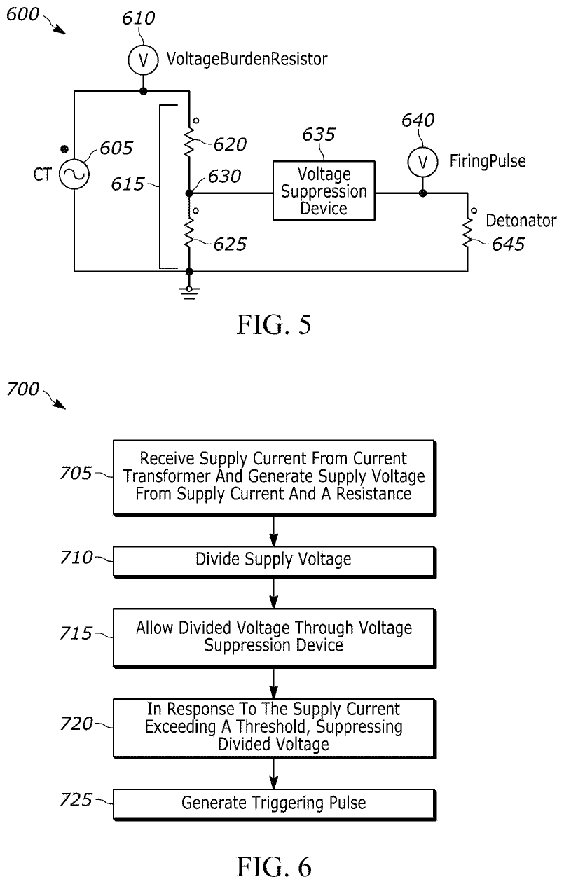

The circuit 600 of FIG. 5 functions according to a method 700 illustrated by a flowchart in FIG. 6. Although the method 700 is described in conjunction with the circuit 600 as described herein, the method 700 could be used with other systems and devices. In addition, the method 700 may be modified or performed differently than the specific example provided. The method 700 includes receiving a supply current from a current transformer and generating a supply voltage with the supply current and a resistance (BLOCK 705). The method 700 also includes dividing the supply voltage (BLOCK 710). In some instances, the voltage is divided by a resistive voltage divider. The method 700 also includes allowing the divided voltage through a voltage suppression device (BLOCK 715). In some instances, the voltage suppression device functions as an open circuit. The method 700 also includes, in response to the supply current exceeding a threshold, suppressing the divided voltage with the voltage suppression device (BLOCK 720). In some instances, the threshold is a predetermined current threshold. In some instances, the suppression of the divided voltage is ended by the voltage suppression device functioning as a short circuit. The method also includes generating a triggering pulse (BLOCK 725). In some instances, the circuit 600 is used control a detonator of a current limiting system with a generic voltage suppression device (for example, voltage suppression device 635). In these instances, the load 645 is a detonator. In these instances, the detonator is triggered by the divided voltage being suppressed.

Another instance of the electronic circuit 515 of the control system 500 (a circuit 800) is illustrated in FIG. 7. The circuit 800 differs from the circuit 600 illustrated by FIG. 5 by using a transient-voltage-suppression (TVS) device 835. The circuit 800 includes a current transformer 805 configured to receive a current signal. In some instances, the is received from a high voltage line, such as the high voltage line 505. The current transformer 805 outputs a supply voltage at a first node 810 of the circuit 800. The supply voltage is supplied to a voltage divider 815 including a first resistor 820 and a second resistor 825. A second node 830 is between the first resistor 820 and the second resistor 825. The voltage is supplied from the second node 830 to the TVS 835. The TVS 835 is connected to a third node 840. In some instances, the TVS 835 determines whether a current associated with the supply voltage exceeds a current threshold. When the current does not exceed the current threshold, the TVS 835 functions as an open circuit so that no voltage or current is supplied to the third node 840. When the current does exceed the current threshold, the TVS 835 functions as a short circuit so that a voltage or current signal is supplied to the third node 840. The signal is provided across a load 845. The circuit 800, although discussed with respect to being implemented in a current limiting system 100, may be used in other applications.

The circuit 800 of FIG. 7 functions according to a method 900 illustrated by a flowchart depicted in FIG. 8. Although the method 900 is described in conjunction with the circuit 800 as described herein, the method 900 could be used with other systems and devices. In addition, the method 900 may be modified or performed differently than the specific example provided. The method 900 includes receiving a supply current from a current transformer and generating a supply voltage with the supply current and a resistance (BLOCK 905). The method 900 also includes dividing the voltage (BLOCK 910). In some instances, the voltage is divided by a resistive voltage divider. The method 900 also includes opening the TVS to allow the divided voltage through the TVS (BLOCK 915). The method 900 also includes, in response to the supply current exceeding a threshold, suppressing the divided voltage (BLOCK 920). In some instances, the threshold is a predetermined current threshold. In some instances, the suppressing the divided voltage is caused by TVS closing to function as a short circuit. The method also includes generating a triggering pulse (BLOCK 925). In some instances, the circuit 800 is be used control a detonator of a current limiting system with a TVS. In these instances, the load 845 is a detonator. In these instances, the detonator is triggered by the divided voltage being suppressed.

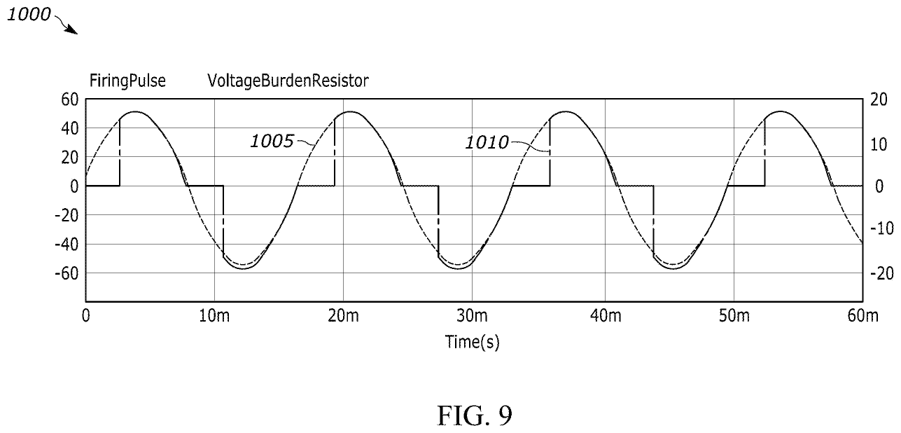

The output of a current transformer and a firing pulse applied to a detonator of a current limiting system is illustrated by a graph 1000 shown in FIG. 9. The output and firing pulse are generated by a circuit using a TVS, such as the circuit 800 illustrated by FIG. 7. The x-axis of the graph 1000 represents time in seconds. The y-axis of the graph 1000 represents voltage in volts. The graph 1000 includes a first wave 1005 representing a voltage across a voltage divider (for example, voltage divider 815). In this example, the voltage is taken at the first node 810. The first wave 1005 peaks at approximately 50V and −50V. The graph 1000 also includes a second wave 1010 representing a voltage used as a firing pulse. In the example noted with respect to the first wave 1005, the voltage is taken at the third node 840. The second wave 1010 peaks at approximately 15V and −15V. The second wave 1010 remains at 0V until an input threshold has been reached. In the example illustrated in FIG. 9, the threshold is when the first wave 1005 is approximately 40V or −40V.

As noted above, the electronic circuit 515 of the control system 500 can be implemented in a number of ways. FIG. 10 illustrates another alternative circuit 1100. The circuit 1100 differs from the circuit 600 illustrated by FIG. 5 and the circuit 800 illustrated by FIG. 7 by using a first Zener diode 1140, a second Zener diode 1145, and a TRIAC 1150. The circuit 1100 includes a current transformer 1105 configured to receive a current signal from a high voltage source. In some instances, the signal is received from a high voltage line, such as the high voltage line 505. The current transformer 1105 outputs a supply current proportional to the current through the high voltage source at a first node 1110 of the circuit 1100. The circuit 1100 includes a first resistor 1115 connected at the first node 1110 and a TRIAC 1150 also connected at the first node 1110. In some instances, a supply voltage is created by the supply current across the first resistor 1115. In some instances, the TRIAC 1150 is set to an open condition such that the circuit 1100 is open across the TRIAC 1150. The first resistor 1115 is connected in parallel to a voltage divider 1120 including a second resistor 1125 and a third resistor 1130. A second node 1135 is between the second resistor 1125 and the third resistor 1130. The voltage is supplied from the second node 1135 to a first Zener diode 1140 connected in series to a second Zener diode 1145. In some instances, the first Zener diode 1140 and the second Zener diode 1145 are connected in such a way to create a voltage clipper configured to allow current through when a reference voltage level has been reached. The output of the second Zener diode 1145 is supplied to the TRIAC 1150 to control the TRIAC 1150 to close, creating a short circuit. The TRIAC 1150 is connected between the first node 1110 and a third node 1155. The third node 1155 is between the TRIAC 1150 and a load 1160 (sometimes referred to as a detonator). Thus, once the TRIAC 1150 has closed, the supply voltage outputted by the current transformer 1105 is supplied to the third node 1155. The signal is provided across a load 1160. The circuit 1100, although discussed with respect to being implemented in a current limiting system 100, may be used in other applications.

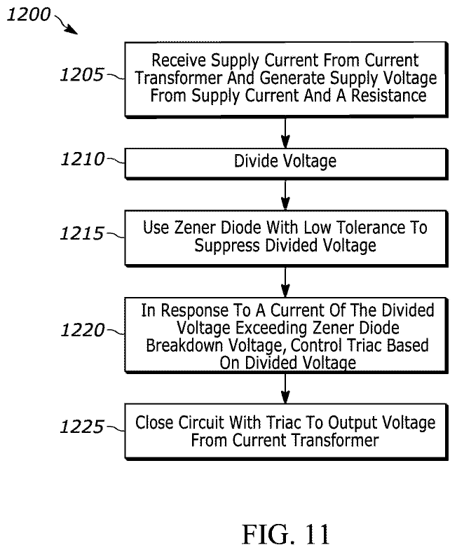

The circuit 1100 of FIG. 10 functions according to a method 1200 illustrated by a flowchart depicted in FIG. 11. The method 1200 can control a detonator of a current limiting system (for example, load 1160) with a TRIAC (for example, TRIAC 1150). Although the method 1200 is described in conjunction with the circuit 1100 as described herein, the method 1200 could be used with other systems and devices. In addition, the method 1200 may be modified or performed differently than the specific example provided. The method 1200 includes receiving a supply current from a current transformer and generating a supply voltage with the supply current and a resistance (BLOCK 1205). The method 1200 also includes dividing the voltage (BLOCK 1210). In some instances, the voltage is divided by a resistive voltage divider. The method 1200 also includes using at least one Zener diode with a low breakdown voltage to suppress the divided voltage (BLOCK 1215). In some instances, the divided voltage is suppressed by the Zener diode connected in series to a second Zener diode to form a voltage clipper. The voltage clipper may prevent the divided voltage from passing through the voltage clipper until a current associated with the divided supply current has exceeded a threshold level. The method 1200 also includes, in response to the divided voltage exceeding the breakdown voltage of the Zener diode, controlling the TRIAC based on the divided voltage (BLOCK 1220). In some instances, this includes supplying the divided voltage to the TRIAC to close the TRIAC. The method 1200 also includes closing a circuit with the TRIAC to output the voltage (BLOCK 1225). In some instances, the circuit 1100 is used control a detonator of a current limiting system with a TRIAC. In these instances, the load 1160 is a detonator, and the signal is a firing pulse. In these instances, the detonator is triggered by the TRIAC activating.

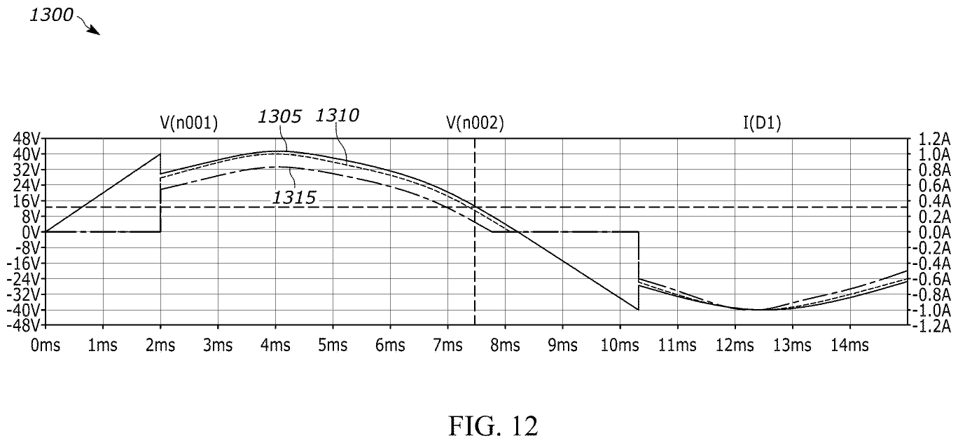

The output if a current transformer and a firing pulse applied to a detonator of the current limiting system is illustrated by a graph 1300 shown in FIG. 12. The output and firing pulse are generated by a circuit using a TRIAC, such as the circuit 1100 illustrated by FIG. 10. The x-axis of the graph 1300 represents time in milliseconds. The y-axis of the graph 1300 represents both voltage in volts and current in amps. The graph 1300 includes a first wave 1305 represents a voltage across a voltage divider (for example, voltage divider 1120). In this example, the voltage is taken at the first node 1110. The first wave 1305 peaks at approximately 40V and −40V. The graph 1300 also includes a second wave 1310 representing a voltage used as a firing pulse. In the example noted with respect to the first wave 1305, the voltage is taken at the third node 1155. The second wave 1310 peaks at approximately 40V and −40V. The second wave 1310 remains at 0V until an input threshold has been reached. In the example illustrated in FIG. 12, the threshold is when the first wave 1305 is approximately 40V or −40V. The graph 1300 also includes a third wave 1315 representing a current corresponding to the voltage represented by the second wave 1310. The third wave 1315 peaks at approximately 1A and −1A. Like the second wave 1310, the third wave remains at 0A until an input threshold has been reached. In the example illustrated in FIG. 12, the threshold is when the first wave 1305 is approximately 40V or −40V.

Various features and advantages of the embodiments and aspects described herein are set forth in the following claims.

What is claimed is:

1. A current limiting system comprising:
a current limiter for a high-voltage power distribution system having a primary path and a secondary path, the current limiter configured to direct an input current to flow through the primary path while the primary path is closed, and direct the input current to flow through the secondary path while the primary path is open;
an interrupter configured to receive a triggering signal and, in response to receiving the triggering signal, open the primary path; and
a current sensing system including a voltage divider and a voltage suppression device, the current sensing system configured to:
receive the input current;
divide, with the voltage divider, a voltage associated with the input current into a divided voltage;
in response to the input current exceeding a predetermined current threshold, output the divided voltage as the triggering signal.

2. The current limiting system of claim 1, wherein the voltage suppression device is a transient-voltage suppression (TVS) device.

3. The current limiting system of claim 2, wherein the TVS device is set to an open state under a normal operating condition.

4. The current limiting system of claim 2, wherein the TVS device is set to a closed state during an abnormal operating condition.

5. The current limiting system of claim 1, wherein the voltage suppression device includes a first Zener diode, a second Zener diode, and a TRIAC.

6. The current limiting system of claim 5, wherein the TRIAC is set to an open state during a normal operating condition.

7. The current limiting system of claim 6, wherein the first Zener diode and the second Zener diode are configured to form a voltage clipper.

8. The current limiting system of claim 7, wherein the TRIAC is configured to receive an output of the voltage clipper to control a state of the TRIAC.

9. The current limiting system of claim 6, wherein the TRIAC is set to a closed state during an abnormal operating condition.

10. The current limiting system of claim 1, wherein the secondary path is a current limiting fuse configured to melt and gradually reduce current flow.

11. A method of limiting a current in a high-voltage power distribution system, the method comprising:
directing, with a current limiter of the high-voltage power distribution system, the current limiter having a primary path and a secondary path, an input current to flow through the primary path while the primary path is closed;
directing, with the current limiter, the input current to flow through the secondary path while the primary path is open;
receiving, at an interrupter of the high-voltage power distribution system, a triggering signal; and
in response to receiving the triggering signal, opening the primary path with a current sensing system including a voltage divider and a voltage suppression device by:
receiving, with the current sensing system, the input current;
dividing, with the voltage divider, a voltage associated with the input current into a divided voltage; and
in response to the input current exceeding a predetermined current threshold, outputting the divided voltage as the triggering signal.

12. The method of claim 11, wherein the voltage suppression device is a transient-voltage suppression (TVS) device.

13. The method of claim 12, further comprising setting the TVS device to an open state under a normal operating condition.

14. The method of claim 12, further comprising setting the TVS device to a closed state during an abnormal operating condition.

15. The method of claim 11, wherein the voltage suppression device includes a first Zener diode, a second Zener diode, and a TRIAC.

16. The method of claim 15, further comprising setting the TRIAC to an open state during a normal operating condition.

17. The method of claim 16, further comprising constructing, with the first Zener diode and the second Zener diode, a voltage clipper.

18. The method of claim 17, further comprising controlling, by an output of the voltage clipper, a state of the TRIAC.

19. The method of claim 15, further comprising setting the TRIAC to a closed state during an abnormal operating condition.

20. The method of claim 11, wherein the secondary path is a current limiting fuse configured to melt and gradually reduce a current flow.
